(19) United States
(12) Patent Application Publication
(10) Pub. No.: US 2003/0093372 A1
(43) Pub. Date: May 15, 2003

(54) Customizable offline payment plug-in for payment server

(75) Inventors: O. Michael Atogi, Raleigh, NC (US); Christopher Meyer, Apex, NC (US); Mark R. Wainwright, Durham, NC (US)

Correspondence Address: Gerald R. Woods, IBM Corporation T81/503, PO Box 12195, Research Triangle Park, NC, 27709, US

(73) Assignee: International Business Machines Corporation, Armonk, NY

(21) Appl. No.: 10/007,858

(22) Filed: Nov. 13, 2001

(51) Int. Cl. G06F 17/60

(52) U.S. Cl. 705/40

(57) ABSTRACT

Online commerce is often conducted in a network including buyer computers, seller computers, financial institution computers and a payment management computer, which provides payment management services to sellers. Payment management software makes use of a generic framework including Payment Instruction, Capture, Refund, Account and Batch data structures. The generic framework is extended to support transactions which conform to uncommon payment protocols, for example, by shipping the merchandise Collect On Delivery or COD. The Payment Instruction data structure is modified to include two seller-definable fields, each of which can be written with data required for the particular type of transaction being modeled. The Account data structure is modified to include a field for receiving data identifying the particular type of transaction being modeled..

### FIELD OF THE INVENTION

The present invention relates to payment processing systems and more particularly to a customizable offline payment plug-in for a payment server.

### BACKGROUND OF THE INVNETION

Paying others for goods or services is one of the oldest, most basic practices of mankind. Currency in the form of coins has existed for more than 2000 years. Currency in the form of printed paper or bills has been around for perhaps 400 years. Allowing buyers to “pay” for goods and services by giving the provider a written instrument that could be presented to a third party for payment, in other words a bank draft or bank check, has been around for many years for commercial transactions but relatively fewer years for consumer transactions.

Credit cards, introduced more than 50 years ago, enabled a buyer to pay for goods or services by letting a seller take an imprint of the buyer's credit card. If the seller was satisfied that the buyer was who he or she purported to be, a task accomplished by comparing the buyer's signature on a receipt to a signature on the credit card or by asking for additional forms of identification, the buyer received the goods or services. At the end of the day or on some other regular schedule, the seller submitted the imprints to an agent for the credit card issuer and received prompt payment from the issuer, usually by having funds transferred into the seller's bank account. While the buyer authentication process hasn't changed much over time, improvements in communications and computer technology allow a seller to call in or electronically transmit a card number to the card issuer to obtain on-the-spot verification that the cardholder has sufficient funds on deposit with the card issuer to cover the proposed transaction.

Improvements in communications and computer technology have also had a much more fundamental effect on way business-to-business, business-to-government or consumer-to-business transactions are now routinely conducted.

There are probably very few adults (or children for that matter) who haven't heard of the Internet, a global network of interconnected computers which permit a computer user to communicate, often on a near real-time basis, with computers or computer users virtually anywhere on the globe. In the beginning, the Internet amounted to a handful of high-speed (for the time) communications links between research laboratories in different locales and was intended solely to facilitate the exchange of scientific data between these laboratories. The use of the Internet for commercial purposes was strongly discouraged even as the number of users and the number of communications links continued to grow. Those who dared to try to exploit the Internet for commercial gain were often reviled in exchanges of notes that could only be characterized as something less than genteel.

However, because the Internet, even in the beginning, offered an inexpensive way to reach an increasing number of computer users, users with commercial goals persisted until Internet users began to accept (grudgingly at first) and then to enthusiastically embrace the Internet as a system over which commerce could take place. Consumers learned they could shop from sellers located all over the world 24 hours a day, ordering unique and/or heavily-discounted goods and services without ever leaving their homes or offices.

Credit cards quickly became the preferred solution for providing payments for transactions initiated on-line. While a consumer could still provide a credit card number directly to a seller and the seller could still check with the card issuer to determine whether to consummate the transaction, just as had been done in traditional face-to-face dealings, the costs of doing on-line business this way were high and some consumers were reluctant to provide credit card information directly to a seller with whom they'd never done business. Problems such as these in trying to conduct online transactions led to the development of payment processing systems.

An online seller uses seller software which provides an online guide to merchandise offered by the seller. The term “merchandise” is intended to be interpreted generically to represent anything that can be ordered online, whether a product or a service. Most merchandise offered online consists of products rather than services. Because of that, this specification will tend to employ product-specific language. Further, while the terms “shopper” and “consumer” and “buyer” are typically associated with individuals obtaining products or services for personal use by themselves or others, the terms should be construed broadly enough to cover individuals who are making purchases on behalf of their employers or other business or government entities.

Online shoppers can see written descriptions or images of the merchandise, make color and size selections where appropriate and tentatively place an order for merchandise by directing the seller software to “place” the merchandise in a “shopping cart” while the shopper continues to browse through the online store. When the shopper has finished browsing and has signaled the seller system that he or she is ready to complete the transaction by providing payment instructions, the seller will typically ask the shopper to provide credit card or other payment information which, once entered by the shopper, is sent to the seller system over a secure or encrypted connection.

Where the online seller uses a payment processing service, the credit card information or other payment information provided by the shopper is normally not retained in the seller system but is forwarded to a payment processing system often running in a computer system located remotely from the seller. The payment processing system accepts the credit card information and other related information, such as the total transaction charges, and sends an online query to the issuer of the card presented by the shopper to determine whether the card issuer is willing to approve the proposed transaction.

If the card issuer approves the transaction, the payment processing service notifies the seller and takes steps necessary to have the seller's account credited for the correct amount of money. The seller completes the online transaction by authorizing shipment of the ordered merchandise.

Typically, the shopper is unaware of the existence of the payment processing service. As far as the shopper is concerned, he or she provides the requested credit card information to the seller, waits a bit online while the seller looks it over and then receives online notification that the transaction is either been approved or rejected by the seller.

In order to allow payment processing software to interoperate with many different seller systems, the payment processing software is typically designed with a standard interface with which data exchanged between the payment processing software and any associated seller system must comply. This is not to say, however, that every seller system interacts identically with a payment processing system.

Over time, different types of credit processing agents developed different payment protocols which member sellers were required to observe when accepting the credit instrument (usually a card) offered by the credit processing agent. To accommodate the differences among payment protocols required by different credit processing agents, the concept of a payment protocol plug-in was developed. Each payment protocol plug-in is used to process transactions using a particular payment protocol and includes definitions of all of the information that needs to be exchanged among three of the participants (seller, payment server and credit processing agent) to a transaction in order to complete a transaction initiated by the fourth participant, the buyer. One thing that should be understood is that while reference is made a credit processing agent as if it were a single entity, depending on the type of payment protocol, the term should be construed broadly enough to encompass the network of entities (for example, the card issuer, the seller's bank, etc.) which are actually involved in consummating the transaction.

The strength of developed payment protocol plug-ins is that they completely define the steps required to complete a transaction according to a specified payment protocol with a predefined set of actions, data structures and state transitions.. The weakness of developed payment protocol plug-ins is that they are thus inflexible and can't be used where a seller wants to do business in accordance with an unsupported payment protocol.

On a global scale, there are a significant number of sellers who want to have an online presence or storefront through which they can provide information about their goods or services to the multitudes of online shoppers but who also want to be able to use the payment processing software to track transactions made using payment protocols customized to the seller's particular requirements or which are used infrequently on a global scale even though they may be regionally popular. The act of payment under many of these protocols is often offline to the systems being discussed. Existing payment protocol plug-ins lack the flexibility to support offline payment protocols which have been tweaked to meet a seller's peculiar requirements or to conform to a particular, infrequently-used offline payment protocol.

### SUMMARY OF THE INVENTION

The present invention solves the problem of the inflexibility of existing payment protocol plug-ins and gives a seller the capability to define a customized payment protocol based on a standard payment protocol plug-in framework without coding. The invention is used with a payment management program which includes one or more payment protocol plug-ins normally used to control online funds transfers from a financial institution to a seller account following placement of a merchandise order by a buyer with the seller. Each of the payment protocol plug-ins implements a payment model characterized by a Payment Instruction data structure describing the payment instructions required to complete the transaction, a Capture data structure describing the state of a specific transaction in which the seller collects funds against the Payment Instruction, a Refund data structure which describes the state of a specific transaction through which a seller returns funds to the buyer using the associated Payment Instruction, a Batch data structure which defines a set of Captures and Refunds to be processed through the financial system as a unit, and an Account data structure which describes the relationship between the seller and a settling financial agent. In one embodiment, the invention is characterized as a method of enabling a seller to extend the data structures in the payment model. The method includes the step of adding at least one seller-defined field to the Payment Instruction data structure to support a seller's entry of information unique to the specific offline method being modeled. The method further includes the step of adding a field to the Account data structure to identify the offline method being modeled.

A significant advantage of the present invention is that it permits a seller to make use of an existing payment management infrastructure and interfaces to provide an “accounting system” which records the state of offline transactions rather than causing their execution.

### BRIEF DESCRIPTION OF THE DRAWINGS

While the specification concludes with claims particularly pointing out and distinctly claiming that which is regarded as the present invention, details of a preferred embodiment of the invention may be more readily ascertained from the following detailed description when read in conjunction with the accompanying drawings wherein:

FIG. 1 is a high level block diagram of the various computer systems which can be used in connection with an implementation of the present invention;

FIG. 2 is a block or flow diagram showing the logical relationship of the software which runs in the various systems illustrated in FIG. 1;

FIG. 3 is a more detailed block diagram of payment management software in which the present invention may be implemented;

FIG. 4 depicts a generic payment model developed to support online payment transactions; and

FIG. 5 depicts a modified payment model which supports nonstandard offline payment transactions.

### DESCRIPTION OF PREFERRED EMBODIMENT

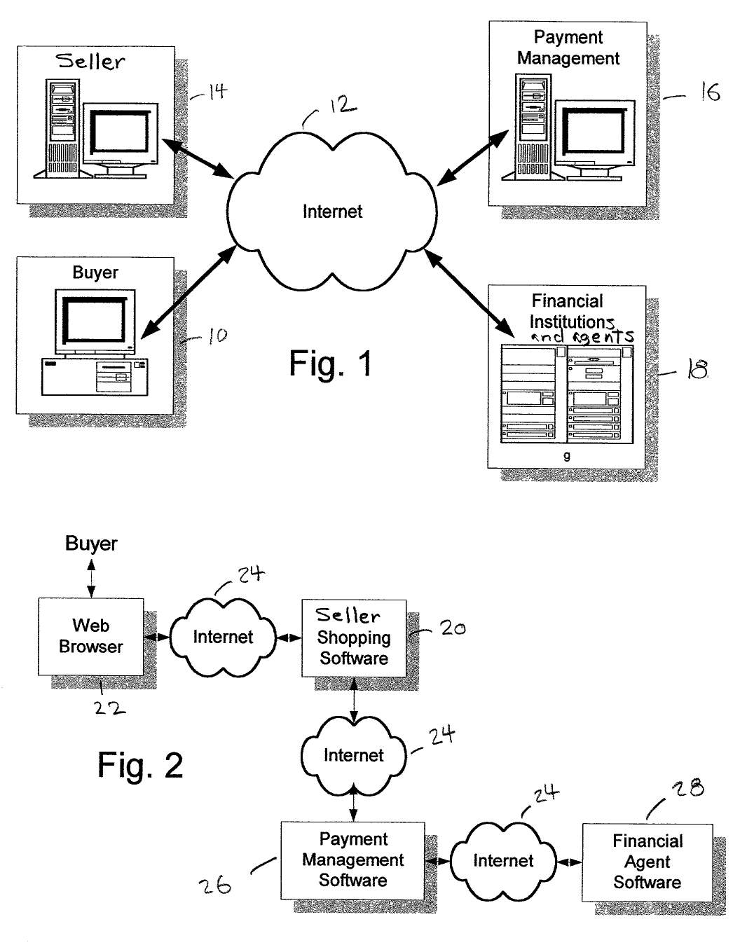

Referring to FIG. 1, the network environment in which the present invention is implemented includes four major categories of computer systems, all of which have specific roles to play in conducting business transactions online. Online commerce cannot exist without buyers who are willing to shop for and order and goods and services online. The buyers are represented in FIG. 1 by a single buyer system 10, typically connected to the Internet 12 through a dial-up or broadband connection provided by an Internet service provider (not shown). In reality, there are millions or hundreds of millions of potential buyers connected to the Internet around the world, all of whom are represented by buyer system 10.

Similarly, online commerce could not exist without sellers willing to offer their goods and services online in what are sometimes referred to as Internet storefronts. All of these sellers are represented by a single seller system 14 typically connected to Internet 12 through a broadband connection.

A typical online shopping experience is one in which the buyer at buyer system 10 finds the seller system 14 either as a result of online or offline ads provided by the seller or as a result of using a Web search engine to identify sources of particular goods or services. A buyer-to-seller connection is established through Internet 12 allowing the buyer to retrieve information about the goods and services offered by the seller. The presentation of the goods and services is controlled by seller software running in the seller system. It is common for seller software to provide online equivalents of a shopping cart in which a buyer can “place” merchandise he or she may want to buy at the end of the visit to the online store.

When a buyer decides he or she is through browsing through the online store and is ready to buy something, a command is sent from the buyer system 10 to the seller system 14 that the buyer is ready to “check out” by placing an order for merchandise still in the buyer's online shopping cart. The seller system 14 responds by asking the buyer to indicate how the merchandise is to be paid for (the payment protocol) and how it is to be shipped. When the buyer responds with the requested information, the seller system 14 sets up a connection to the payment server 16 through Internet 12 and passes the payment-related information on to payment server 16.

Where the payment requires online transfers of funds, which the bulk of Internet shopping transactions do, the payment server 16 obtains approval for the proposed transaction from the appropriate financial agent (often a bank that has issued a credit card to the shopper) and sets up connections through Internet 12 to the financial institutions, all represented by system 18, that are parties to the funds transfers. Notwithstanding the use of the single block 18, Financial Institution systems 18 can include multiple entities, including the bank that issued the credit card, the bank that has the seller's account, intermediate agents, etc.

If the necessary approvals are obtained and required instructions have been exchanged among payment server 16 and financial institutions 18 through Internet 12, payment server 16 notifies the seller system 14 that the transaction is approved. The seller system 14, in turn, notifies the buyer and provides shipment information.

Virtually all of what goes on among the seller system, the payment server and the financial institutions is invisible to the buyer, who will have no visible indication that his proposed transaction has been reviewed by anyone other than the seller. This can be seen more clearly in FIG. 2, which is a “software-level” view of the type of transaction described above.

A human buyer sitting at his personal computer or other workstation interacts with seller shopping software 20 through a web browser 22 running on the buyer's personal computer and a connection through the Internet 24. Until the buyer decides to conclude his online shopping in the seller's Internet storefront, the only two parties to the transaction are the buyer and the seller. When the buyer does conclude the transaction and makes payment information available, the seller shopping software 20 sets up a connection with the payment management software 26, usually through the Internet 24, and passes on the payment information as necessary. The payment management software 26, in turn, sets up connections to one or more sets of financial agent software 28 at one or more financial institutions, to obtain an approval or rejection of the proposed transaction and to effect any required funds transfers. The status (e.g., approved or rejected) of the request and other necessary information are relayed back to the seller shopping software and then to the buyer. While the drawing shows all connections among the systems being through the Internet, in some situations the seller and the payment management systems or the payment management systems and the financial institutions/agents may be made through leased lines, bypassing the Internet.

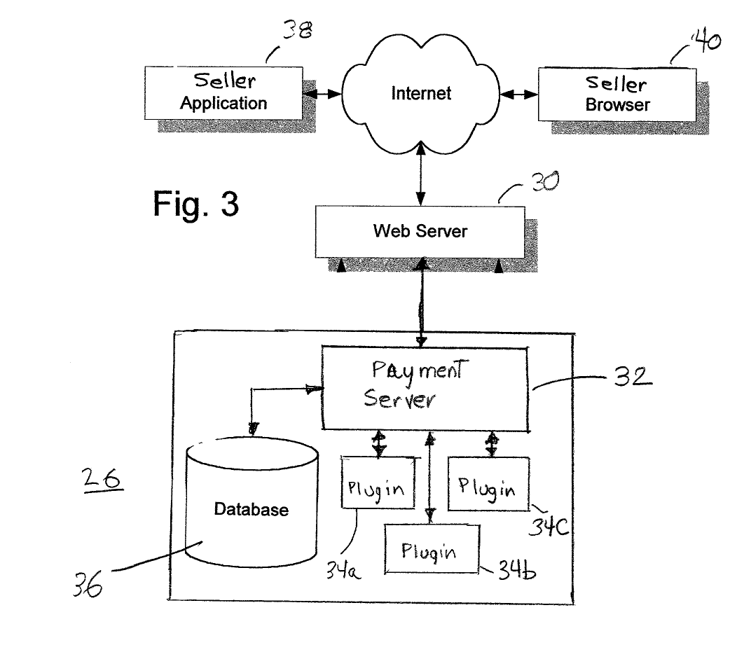

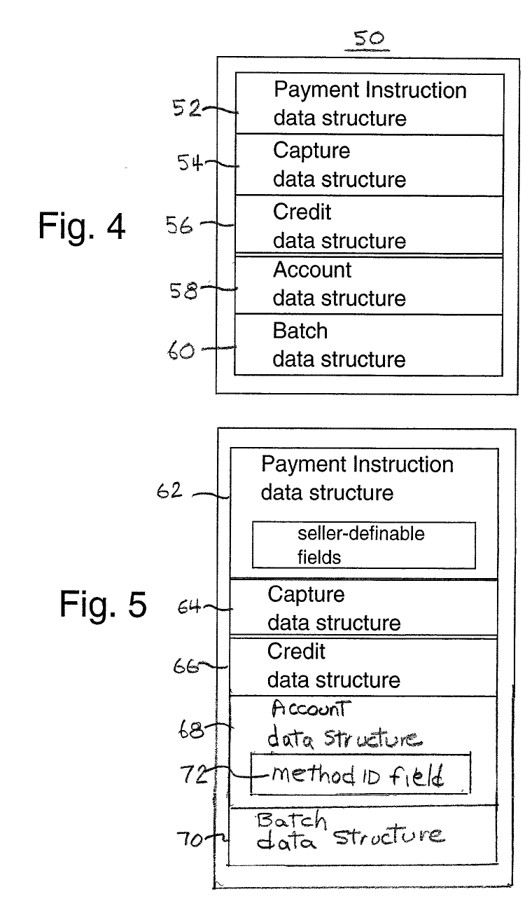

FIG. 3 is a more detailed view of the components of the payment management software 26 which interfaces to the Internet through a Web application server or Web server 30. In a preferred embodiment, the payment management software is Java-based and the Web server 30 establishes an environment in which the payment management software can run its Java servlets and establish external communications using HTTP requests. In one embodiment, the payment manager itself provides XML responses.

The payment management software infrastructure is intended to support multiple sellers, all using the system concurrently to process orders from their respective online storefronts. The infrastructure also allows sellers to be authorized to use different payment protocols, implemented in payment protocol plug-ins to be described in more detail below.

The payment management software 26 includes a payment server 32 which deals with payment requests sent to software 26. Payment server 32 interfaces with one or more payment protocol plug-ins, represented by plug-in blocks 34a, 34b, 34c, which implement different predefined payment protocols. The payment management software 26 further includes a database 36, preferably a relational database, that is used to store configuration data, such as payment protocol plug-in configurations, authorization data and runtime data, such as orders or other transactional data.

The payment management software includes a defined application programming interface or API in the data path between a seller application 38 and the payment server 32. The API supports flexible integration of the seller application and the payment management software and provides function calls for payment processing, queries and administration. The payment management software may also include a user interface to a seller browser 40 which supports interactive access to payment management functions and parameters.

As noted earlier, a number of different protocol plug-ins have been developed to handle specific payment protocols. While sellers need these protocol plug-ins for executing transactions conforming to the existing payment protocols, they also need some way to handle unique or unusual transactions. One way they could do that is to develop a complete protocol plug-in specific to each unique or unusual payment protocol they want to support. The present invention accomplishes the objective in accord with an alternative approach, namely manipulation of the data structures which exist in a generic payment framework 50 to be described below.

The generic framework 50 includes several key data structures, one of which is an Payment Instruction data structure 52 representing all of the instructions and information needed from a buyer or payer in order for the seller or payee to collect money. Once this information is gathered, the seller may or may not collect the money in a single funds transfer but does not have to go back to the buyer for additional information. Another key data structure in the generic payment framework is a Capture data structure 54 representing the state of a transaction through which the seller collects funds against the Payment Instruction. Depending on the payment type, the Capture data structure may define an authorization which is explicit, such as a credit card approval, or implicit. A Refund data structure 56 identifies a credit made against the amount of money identified in a Payment Instruction data structure. A Refund data structure, which describes the state of a transaction in which funds are being returned to a buyer, can be created where the buyer returns merchandise or cancels an order prior to fulfilment. An Account data structure 58 describes the relationship between a seller and a financial institution or its agent responsible for the necessary funds transfers. A Batch data structure 60 is associated with an Account and a seller and represents a collection of Captures and Refunds that are to be processed or settled as a unit.

The data structures described above within framework 50 are extended to support the entry of data and instructions needed by specific payment protocols. Standard fields within each data structure are used to received data required by the specific payment protocol. The extensions to the framework may take the form of a payment protocol plug-in. Once the extensions required to support a specific payment protocol have been defined, the extended framework is no longer useful for unusual or unique transactions, often involving offline transfers of funds.

One example of this class of transaction is Collect On Delivery, where the seller authorizes a shipping company or agent to collect payment for merchandise when that merchandise is actually delivered to a designated recipient. The shipping company or agent then forwards the payment back to the seller. Another example is a “convenience store” method popular in some parts of the world where the merchandise may be ordered online but not actually shipped until the buyer provides payment at a local convenience store. The term “convenience store” should be interpreted generically since the organization receiving payment may not be a convenience store in the ordinary sense of the term but instead may be a catalog store or any other agent authorized to collect payments on behalf of the seller. Another example of a transaction where payment may not be via online funds transfers is a shopper loyalty points transaction where a shopping can build up points based on past purchases and then use those points as payment for current purchases. Finally, gift certificates and cash tendered directly to a seller as payment for online orders fall within the general class of transactions defined as having online orders but offline (to the payment management system) payments.

While transactions falling with the stated class may not have been contemplated when the payment management system was first developed, it is nevertheless desirable for a seller to be able to capture and process those transactions using the same basic methodology as he uses for pure online transactions. The present invention is based on extensions to the framework discussed above which allows a seller to modify (further extend) the data structures to support nonstandard payment models.

One of the changes is to further extend the Payment Instructions data structure 62 to include seller-defined fields containing non-standard data unique to the nonstandard payment process being modeled. In accordance with a preferred embodiment of the invention, two additional fields of finite length are added to the Payment Instructions data structure to permit the seller to define up to two additional parameters required by the non-standard application of the standard model. The parameters will be determined by the requirements of the nonstandard process being modeled. For example, where a seller wants to set up a Collect On Delivery payment model, one of the additional fields is dedicated to the shipping address. For a loyalty points process as described above, the additional Order data structure fields could be used to store the customer's name and the number of points being redeemed by the online purchase.

The only limit on the kind of information that a seller can enter in the fields added to the Payment Instruction data structure is the seller's creativity in defining a custom offline payment protocol. For example, the added fields could be used to define a barter transaction in which the buyer's “payment” takes the form of goods or services to be delivered from the buyer to the seller.

Another of the changes is in the Account data structure, which ordinarily describes an account relationship between the seller and the financial institution or its agent responsible for transferring funds into the account. Since an offline payment method does not involve funds transfers from a financial institution or agent, in accordance with the invention, a field can be added to identify the particular offline payment model being modeled.

Of course, standard field already existing in data structures in the framework must be extended to support the entry of generic data (such as currency employed, amount of transaction, etc.) for the particular payment method. For example, for a Collect on Delivery method, the Capture data structure 64 would contain a COD form number as the “approval code”. Similarly for a loyalty points method, a request for “payment” is implied when the payment manager asks an external program to verify that the shopper really has accumulated enough loyalty points to support the proposed online transaction. Method-specific changes in a Refund data structure 66 and a Batch data structure 70 will often be required but can be accomplished using standard fields in those data structures..

While there has been described what is considered to be a preferred embodiment of the invention, variations and modifications in the preferred embodiment may occur to those skilled in the art. Therefore, it is intended that the appended claims shall be construed to include both the preferred embodiment and all such variations and modifications as fall within the true spirit and scope of the invention.

What is claimed is:

1. For use with a payment management program which includes one or more payment protocol plug-ins normally used to control online funds transfers from a financial institution to a seller account following placement of a merchandise order by a buyer with the seller, each of the payment protocol plug-ins being produced by extending a framework characterized by a Payment Instruction data structure describing payment instructions for completing the transaction, a Capture data structure describing the state of a specific transaction by which a seller is compensated, a Refund data structure describing the state of a specific transaction by which compensation is returned to a buyer, a Batch data structure defining a set of Captures and Refunds to be processed as a unit and an Account data structure describing a relationship between a seller and a financial agent responsible for transferring funds into a seller account, a method of enabling a seller to modify the data structures in the framework to represent a different type of transaction, said method comprising the steps of:
adding at least one seller-defined field to the Payment Instruction data structure to support a seller's entry of information unique to the specific offline method being modeled; and
adding at least one field to the Account data structure to identify the offline method being modeled.

2. A method as defined in claim 1 wherein each seller-defined field added to the Payment Instruction data structure comprising a field of finite length.

3. An article of manufacture comprising a computer useable medium having a computer readable program embodied in said medium, wherein the computer readable program defines a payment management program which includes one or more payment protocol plug-ins normally used to control online funds transfers from a financial institution to a seller account following placement of a merchandise order by a buyer with the seller, each of the payment protocol plug-ins extending a framework characterized by a Payment Instruction data structure describing payment instructions for completing the transaction, a Capture data structure describing the state of a specific transaction by which a seller is compensated, a Refund data structure describing the state of a specific transaction by which compensation is returned to a buyer, a Batch data structure defining a set of Captures and Refunds to be processed as a unit and an Account data structure describing a relationship between a seller and a financial agent responsible for transferring funds into a seller account, said computer readable program further including program code adding at least one seller-definable field to the Payment Instruction data structure to support a seller's entry of information unique to a specific method being modeled and program code adding at least one seller-definable field to the Account data structure to identify the method being modeled.

4. A payment management system including one or more payment protocol plug-ins normally used to control online funds transfers from a financial institution to a seller account following placement of a merchandise order by a buyer with the seller, each of the payment protocol plug-ins being implemented by extending a framework characterized by a Payment Instruction data structure describing payment instructions for completing the transaction, a Capture data structure describing the state of a specific transaction by which a seller is compensated, a Refund data structure describing the state of a specific transaction by which compensation is returned to a buyer, a Batch data structure defining a set of Captures and Refunds to be processed as a unit and an Account data structure describing a relationship between a seller and a financial agent responsible for transferring funds into a seller account, said system further including:
seller-defined storage areas in the Payment Instruction data structure for receiving seller-entered information unique to a specific offline method being modeled, and
a seller-defined storage area in the Account data structure identifying the method being modeled.

5. A system as set forth in claim 4 wherein each seller-defined storage area comprises a field of finite length.
